(19) United States
(12) Patent Application Publication
(10) Pub. No.: US 2002/0096891 A1
(43) Pub. Date: Jul. 25, 2002

(54) Interconnected lock with asymmetric carrier

(76) Inventors: Peter K. Bates, Framingham, MA (US); Brian David Blankenship, Colorado Springs, CO (US)

Correspondence Address: MICHAEL BEST & FRIEDRICH LLP, 3773 CORPORATE PARKWAY, SUITE 360, CENTER VALLEY, PA, 18034-8217, US

(21) Appl. No.: 09/765,787

(22) Filed: Jan. 19, 2001

(51) Int. Cl. E05B 3/08

(52) U.S. Cl. 292/336.5

(57) ABSTRACT

An asymmetric carrier for an interconnected lock assembly mounted in a door comprising a carrier body having a rack fixably attached to the carrier body. The carrier body has an asymmetric cam surface on at least one side of the carrier body. The asymmetric cam surface is engageable by a cam of the interconnected lock assembly in either a clockwise or counter clockwise direction to move the carrier body in a vertical direction. The cam imparts a horizontal resultant force on the carrier body in the same direction and in generally the same magnitude, regardless of rotational direction of the cam.

### TECHNICAL FIELD

This invention relates generally to interconnected lock assemblies used to secure doors. More particularly, the present invention relates to an interconnected lock assembly with an asymmetric carrier component which provides equal carrier loads and motion for equivalent rotational distances of a cam, regardless of the direction of rotation.

### BACKGROUND OF THE INVENTION

An interconnected lock assembly is characterized by an inside handle, either knob or lever, which simultaneously retracts both a deadlatch and a deadbolt. Such a lock assembly is commonly found in public accommodations such as hotels and motels in which, for security purposes, the occupant wishes to set both a deadlatch and a deadbolt. The same type of lock assembly may also be found in a residential or other environments. It is particularly important that both locks be retracted by the turning of a single inside operating member as it has been found that in the event of a fire or other panic situation it is desirable that the occupant only need turn a single knob or lever to operate all of the lock mechanisms in a particular door.

Such interconnected lock assemblies have been on the market for a number of years. Some interconnected lock assemblies are designed such that the rack or rack carrier component may move to different heights when the handles are rotated by equal amounts in opposite directions. One prior art device uses a rack with a flat surface interfacing a symmetric cam which raises the rack by equal amounts for equal rotational distances of the handles, regardless of the direction of rotation.

One problem with interconnected lock assemblies is that the rack or rack carrier component, depending on the design, is subjected to different loads when the lower handles are rotated in different directions. This can result in increased wear of the rack, rack carrier, and of the interconnect mounting bracket, or carrier interface. This can result in increased play in the interconnect components, leading to premature failure of the interconnect lock.

The foregoing illustrates limitations known to exist in present interconnected lock assembly designs. Thus, it is apparent that it would be advantageous to provide an alternative directed to overcoming one or more of the limitations set forth above. Accordingly, a suitable alternative is provided including features more fully disclosed hereinafter.

### SUMMARY OF THE INVENTION

It is therefore an object of the present invention to provide an interconnected lock assembly with an asymmetric carrier component which provides equal carrier loads and motion for equivalent rotational distances of a cam, regardless of the direction of rotation. This and other objects of the present invention are provided by an asymmetric carrier for an interconnected lock assembly mounted in a door comprising a carrier body having a rack fixably attached thereto. The carrier body has an asymmetric cam surface on at least one side of the carrier body. The asymmetric cam surface is engageable by a cam of the interconnected lock assembly in either a clockwise or counter clockwise direction to move the carrier body in a vertical direction. The cam imparts a horizontal resultant force on the carrier body in the same direction and in generally the same magnitude, regardless of rotational direction of the cam.

### BRIEF DESCRIPTION OF THE DRAWINGS

FIG. 1 is an exploded perspective view of the interconnected lock assembly with asymmetric carrier of the present invention;

FIG. 2 is a perspective view of the assembled interconnected lock assembly in accordance with the present invention of FIG. 1;

FIG. 3A is a side elevational view of the assembled interconnected lock assembly with keyless exit, shown without the escutcheon and the inside handle, showing counter-clockwise rotation of the cam in accordance with the present invention of FIG.

FIG. 3B is a side elevational view of the assembled interconnected lock assembly with keyless exit, shown without the escutcheon and the inside handle, in accordance with the present invention of FIG. 1;

FIG. 3C is a side elevational view of the assembled interconnected lock assembly with keyless exit, shown without the escutcheon and the inside handle, showing clockwise rotation of the cam in accordance with the present invention of FIG. 1;

FIG. 4A is a detail view of the cam engaging the asymmetric cam surface of the carrier component in a clockwise direction showing the resultant forces on the asymmetric cam surface, in accordance with the present invention of FIG. 1; and

FIG. 4B is a detail view of the cam engaging the asymmetric cam surface of the carrier component in a counter-clockwise direction showing the resultant forces on the asymmetric cam surface, in accordance with the present invention of FIG. 1.

### DETAILED DESCRIPTION

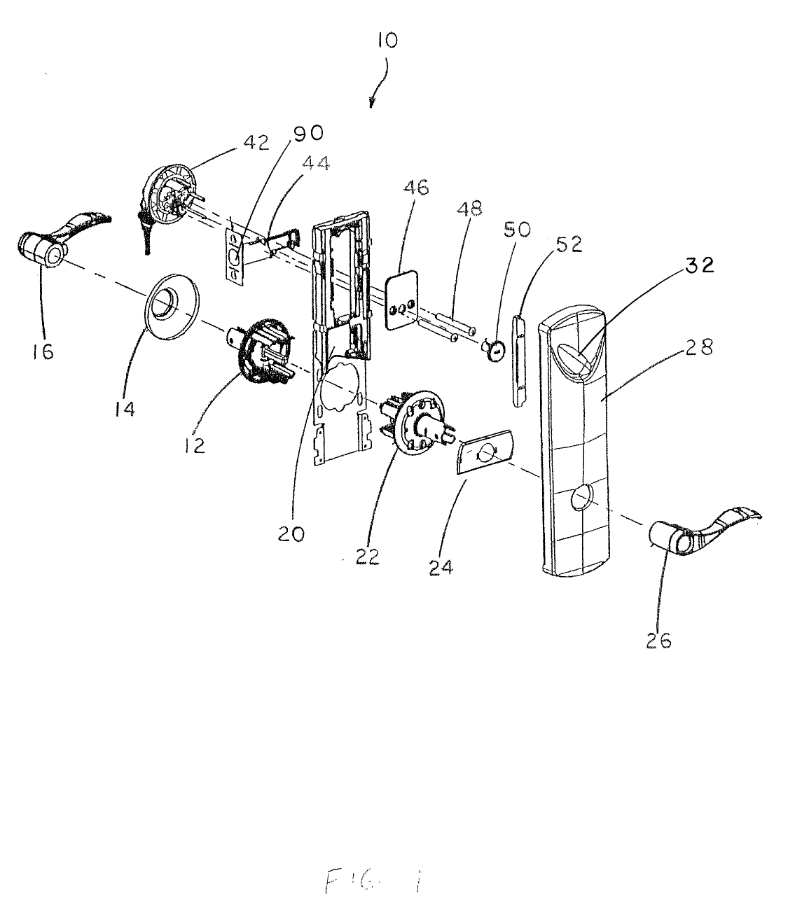

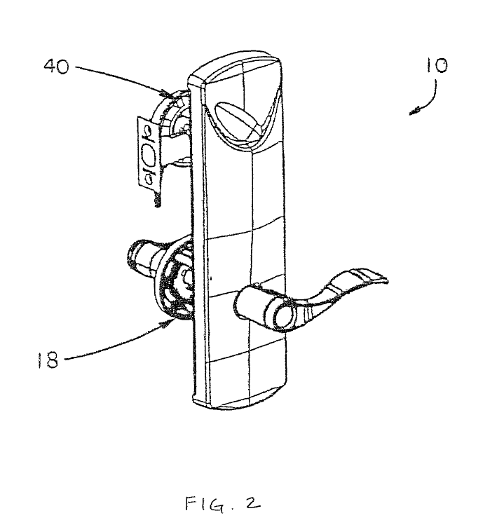

Referring now to the drawings, wherein similar reference characters designate corresponding parts throughout the several views, there is generally indicated at 10 an adjustable interconnected lock assembly with asymmetric carrier of the present invention. Referring specifically to FIGS. 1 and 2, lock assembly 10 comprises a first or lower interconnected lock assembly 18 comprising outside housing assembly 12, rose 14, and outside handle, or knob/lever 16, attached from the outside of a door (not shown) through a first or lower bore in the door, and through a back plate assembly 20 positioned on the inside of the door, to inside housing assembly 22. Interconnect cam 24, escutcheon 28 with attached thumbturn 32, and inside handle, or knob/lever 26 are attached to inside housing assembly 22 on the inside of the door. Although not shown, a latch assembly could be operably connected between outside housing assembly 12 and inside housing assembly 22. Interconnected lock assembly 10 also comprises a second or upper interconnected lock assembly 40 comprising a deadbolt housing assembly 42 and a deadbolt latch assembly 44. Deadbolt housing assembly 42 is attached from the outside of the door through a second or upper bore and operably connected to deadbolt latch assembly 44, and through back plate assembly 20 and secured thereto by deadbolt plate 46 and mounting screws 48. Deadbolt latch assembly 44 includes a deadbolt 90, movable between an extended and a retracted position. Deadbolt housing assembly 42 is operably connected to a deadbolt pinion 50 which engages a deadbolt rack 52 connected to back plate assembly 20 as discussed in detail below. The lower interconnected lock 18 and upper interconnected lock 40 are standard configurations that are well-known in the art, and as such, the workings of these locks will not be described in detail, except as they relate to the present invention.

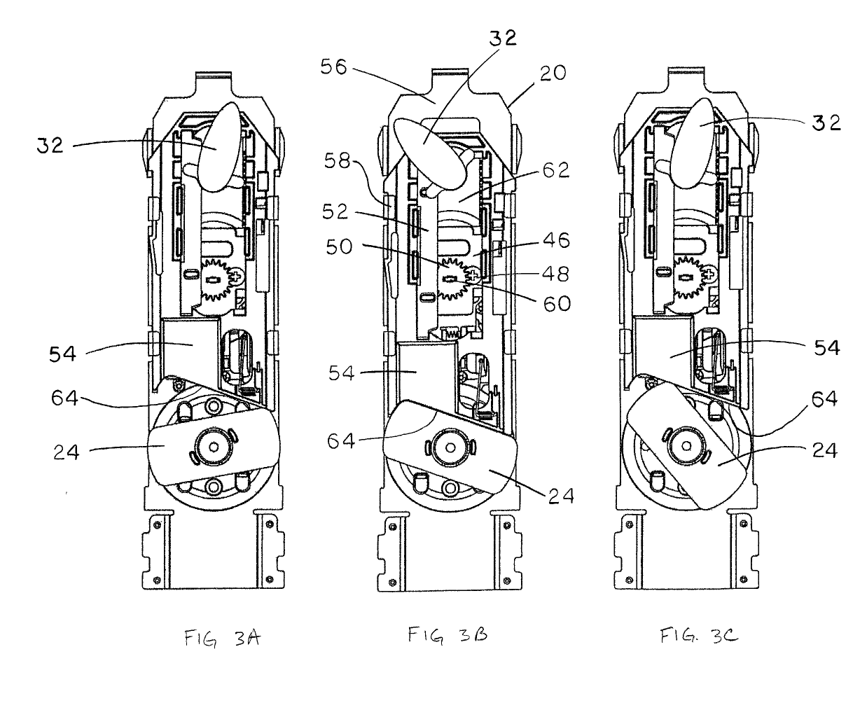

Referring now to FIGS. 3A-3C, interconnected lock 10 shown with escutcheon 28 and inside handle 26 removed. Back plate assembly 20 comprises an asymmetric carrier component 54 vertically movable on, and slidably attached to a back plate 56 by a plurality of tangs 58. Deadbolt rack 52 is oriented vertically and fixedly attached to carrier component 54 such that it engages pinion 50. Thumbturn 32 is pivotally attached to deadbolt rack 52 such that rotation of thumbturn 32 in one direction lowers deadbolt rack 52 and rotation of thumbturn 32 and the other direction raises deadbolt rack 52. Conversely, movement of deadbolt rack 52 causes rotation of thumbturn 32 in a corresponding manner. The rack 52 attached to carrier component 54 causes deadbolt pinion 50 to rotate as carrier component 54 moves either upward or downward. Driver bar 60 co-rotates with deadbolt pinion 50. Rotation of driver bar 60 causes retraction and extension of deadbolt 90 of deadbolt latch assembly 44 in a standard fashion. Accordingly, as carrier component 54 moves upward, deadbolt 90 of deadbolt latch assembly 44 is retracted, allowing the door to be opened.

Interconnected lock 10 is adjustable in that upper lock assembly 40 can move up or down to properly fit the upper bore of the door. Deadbolt plate 46 is movable within a slot 62 in back plate 56 to allow the proper positioning of upper lock assembly 40. Upper lock assembly 40 is then secured to deadbolt plate 46 by mounting screws 48 which secure upper lock assembly 40 in a fixed position. Deadbolt assembly 42 is operably connected to deadbolt pinion 50 by driver bar 60 which is co-rotatingly attached to deadbolt pinion 50.

Referring now to FIG. 3B, asymmetric carrier component 54 is shown in a lowered, or locked position. When carrier component 54 is in a lowered, or locked position, an asymmetric cam surface 64 of carrier component 54 engages cam 24. Cam 24 is attached to inside knob/lever 26 in a co-rotating manner such that rotation of inside knob/lever 26 rotates cam 24 which engages asymmetric cam surface 64, causing carrier component 54 to move vertically, upwardly to a raised, or unlocked position.

Referring again to FIG. 3B, cam 24 a shown in a neutral position in which cam 24 is angled at an angle corresponding to asymmetric cam surface 64. When inside handle 26 is rotated in a counter-clockwise direction, as shown in FIG. 3A, cam 24 also rotates, forcing carrier component 54 upward to an unlocked position. Deadbolt rack 52 moves along with carrier component 54, causing thumbturn 32 to rotate to an unlocked position. Although not shown, movement of carrier component 54 from a lowered position to a raised position retracts deadbolt 90 from a locked position to an unlocked position in a standard manner.

Similarly, when inside handle 26 is rotated in a clockwise direction, as shown in FIG. 3C, cam 24 also rotates, forcing carrier component 54 upward to an unlocked position. Deadbolt rack 52 moves along with carrier component 54, causing thumbturn 32 to rotate to an unlocked position. Again, movement of carrier component 54 from a lowered position to a raised position retracts deadbolt 90 from a locked position to an unlocked position in a standard manner.

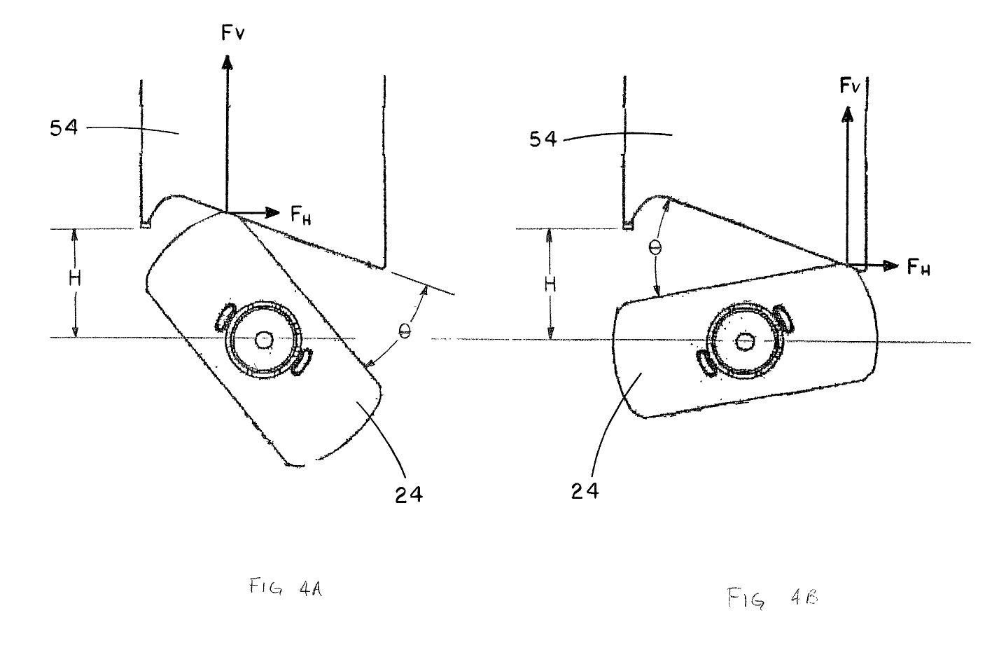

Asymmetric cam surface 64 of asymmetric carrier component 54 is designed such that equal amounts of rotation of inside handle 26 results in equal amounts of vertical movement H of asymmetric carrier component 54 as shown in FIGS. 4A and 4B. In addition, the resultant forces, in the vertical direction Fv and the horizontal direction FH, imparted by cam 24 on asymmetric cam surface 64 of asymmetric carrier component 54 are also equivalent in direction and magnitude, irregardless of rotational direction of inside handle 26. As a result, carrier component 54 is consistently actuated in the same manner every time inside handle 26 is rotated. This results and less wear of the carrier component 54, rack 52, pinion 50, and mounting bracket 56, as well as other associated parts of the interconnected lock 10 in comparison to standard carriers or racks which have opposed horizontal resultant forces when the handle is rotated in opposite directions. The design of interconnected lock 10 can be optimized to handle the single direction of resultant horizontal forces in the manner extending the operational life of the lock 10.

Movement of carrier component 54 from a locked position to an unlocked position, and vice versa, can be accomplished by either rotating inside knob/lever 26, rotating thumbturn 32, or by turning a key to rotate the rotating driver bar 60 of deadbolt assembly 42.

Although the present invention has been described above in detail, the same is by way of illustration and example only and is not to be taken as a limitation on the present invention. Accordingly, the scope and content of the present invention are to be defined only by the terms of the appended claims.

What is claimed is:

1. An asymmetric carrier for an interconnected lock assembly mounted in a door, comprising:
a carrier body;
a rack fixably attached to said carrier body; and
an asymmetric cam surface on at least one side of said carrier body;
said asymmetric cam surface engageable by a cam of said interconnected lock assembly in either a clockwise or counter clockwise direction to move said carrier component in a vertical direction.

2. The asymmetric carrier of claim 1, wherein said cam imparts a horizontal resultant force on said carrier body in the same direction and in generally the same magnitude, regardless of rotational direction of said cam.

3. The asymmetric carrier of claim 1, wherein a specific angular rotation of said cam results in a specific amount of vertical movement of said carrier body, regardless of rotational direction of said cam.

4. The asymmetric carrier of claim 1, wherein said cam surface is at an angle with respect to a horizontal plane.

5. An interconnected lock assembly for mounting in a door, comprising:
a first lock assembly including an inside handle and an outside handle;
a second lock assembly interconnected to said first lock by a rack mounted on a carrier component, wherein said second lock assembly is operably connected to a deadbolt latch assembly, said deadbolt latch assembly comprising a deadbolt movable between an extended position when said carrier component is in a lowered position and a retracted position when said carrier component is in a raised position;
a cam coupled to said inside handle rotatable in either a clockwise or counter-clockwise direction; and
an asymmetric cam surface on at least one side of said carrier;
said asymmetric surface engageable by said cam to move said carrier component in a vertical direction.

6. The interconnected lock assembly of claim 5 wherein said cam imparts a horizontal resultant force on said carrier component in the same direction and in generally the same magnitude, regardless of rotational direction of said cam.

7. The interconnected lock assembly of claim 5, wherein a specific angular rotation of said cam results in a specific amount of vertical movement of said carrier body, regardless of rotational direction of said cam.

8. The interconnected lock assembly of claim 5, wherein said cam surface of said carrier component is at an angle with respect to a horizontal plane.
